(19) United States
(12) Patent Application Publication
(10) Pub. No.: US 2023/0194636 A1
(43) Pub. Date: Jun. 22, 2023

(54) SYSTEMS AND METHODS FOR MAGNETIC CONFIGURATION OPTIMIZATION

(71) Applicant: BIONAUT LABS LTD., Herzliya (IL)

(72) Inventor: Michael SHPIGELMACHER, Los Angeles, CA (US)

(73) Assignee: BIONAUT LABS LTD., Herzliya (IL)

(21) Appl. No.: 17/919,295

(22) PCT Filed: Apr. 19, 2021
(86) PCT No.: PCT/US21/27996

§ 371 Date: Oct. 17, 2022

Related U.S. Application Data
(60) Provisional application No. 63/012,358, filed on Apr. 20, 2020.

(51) Int. Cl. G01R 33/383; H01F 7/02

(52) U.S. Cl. CPC G01R 33/383; H01F 7/0278

(57) ABSTRACT

A system method for magnetic configuration optimization may include one or more memories storing a field distribution dictionary mapping magnetic subcomponents to magnetic field distributions, and one or more processors to generate a plurality of magnetic configurations from the sub-components in the field distribution dictionary, for each configuration, transforming the magnetic field distribution of each of the sub-components to a location and orientation of the sub-component in the configuration, generate a total magnetic field distribution for the configuration by adding the transformed magnetic field distributions of the configuration, for each configuration, generate a performance score for the configuration from the total magnetic field distribution based on at least one first magnetic field parameter to be optimized, and select the configuration with the highest performance score.

### FIELD OF THE INVENTION

Embodiments of the invention relate generally to configurations of permanent magnets and/or electromagnets, such as magnetic configurations in medical device applications. In particular, embodiments of the invention relate to magnetic configuration optimization utilizing pre-calculated magnetic field distribution simulations for multiple magnetic configurations.

### BACKGROUND OF THE INVENTION

For many industrial applications, there is a need to accurately simulate the magnetic field distribution of a particular configuration of permanent magnets or electromagnets (coils) in space. In select cases, it is also necessary to calculate the forces or torques exerted by such a magnetic field on a particular object. As an example, in a medical device application, there may be a need to simulate forces and torques exerted by an external magnetic system of coils and permanent magnets on a catheter with a magnetic tip. Multiple magnetic simulation software packages have been created for this purpose, utilizing a variety of numerical simulation methods. Examples include ANSYS, Maxwell, Opera, and more.

However, all those types of magnetic simulation software rely on numerical methods which require significant computational power and relatively long runtime. This creates a problem for the practitioner who wants to simulate multiple configurations with varying parameters (e.g., different sizes of permanent magnets, different coils sizes/currents/orientations) and select the best configuration for their purposes. Running those configurations serially on a single workstation takes a very long time while running them in parallel on multiple processors or by utilizing cloud computing (e.g., Amazon Web Services' (“AWS”) cloud computing services) is often cumbersome because of the lack of native support for parallelization of the given magnetic simulation software.

Accordingly, there is a need to reduce the computation power and amount of time it takes to simulate magnetic field distributions of multiple configurations of magnets without reducing the accuracy of the simulations.

### SUMMARY OF THE INVENTION

Embodiments of the invention may provide a system and a method for magnetic configuration optimization.

A system and a method for magnetic configuration optimization may include one or more processors configured to pre-calculate magnetic field distributions for each of a plurality of magnetic subcomponents based on parameters of the corresponding magnetic subcomponent, and a magnetization direction or a current direction in the corresponding magnetic subcomponent. The parameters of a magnetic subcomponent that is a permanent magnet may include a material of the magnetic subcomponent, a shape of the magnetic subcomponent, and dimensions of the magnetic subcomponent. The parameters of a magnetic subcomponent that is an electromagnet may include a coil diameter of the magnetic subcomponent, a material type and a wire diameter of the magnetic subcomponent, a number of turns of the magnetic subcomponent, or a current applied to the magnetic subcomponent.

One or more memories may be configured to map, in a field distribution dictionary, each of a plurality of magnetic subcomponents to a corresponding magnetic field distribution for a predefined area.

One or more processors may be configured to generate a plurality of different magnetic configurations from the sub-components in the field distribution dictionary, for each configuration, and store the plurality of magnetic configurations in the one or more memories. The one or more processors may generate a magnetic configuration by randomly selecting magnetic subcomponents of the second configuration from the plurality of mapped magnetic subcomponents, and randomly assigning a location and an orientation for each magnetic subcomponent of the first configuration. Two configurations may be different if either configuration has at least one magnetic subcomponent which is not a magnetic subcomponent in the other configuration, or, if the two configurations have the same magnetic subcomponents, at least one of the magnetic subcomponent's location in the first configuration is different from its location in the second configuration.

The one or more processors may, for each configuration, be configured to retrieve location and orientation of each magnetic subcomponent in the configuration from the one or more memories. For each configuration, the one or more processors may be configured to determine a total magnetic field distribution for the configuration by transforming the magnetic field distribution of each of the sub-components to the location and orientation of the sub-component in the configuration, and adding each of the transformed magnetic field distributions. The one or more processors may be configured to not determine a total magnetic field distribution for a configuration, if the location of each magnetic subcomponent of the configuration is not within a predefined distance from a predefined area or if at least one of the magnetic subcomponent locations of the configuration overlap.

The one or more processors may be configured to, for each configuration, generate a performance score for the configuration from its total magnetic field distribution based on at least one magnetic field parameter to be optimized.

The one or more processors may be configured to suggest an optimized configuration of magnets based on the performance scores of each of the plurality of configurations.

Embodiments of the invention may reduce the processing power and time necessary for simulating magnetic field/gradients/forces distribution and magnetic configuration optimization by avoiding the need to run a complex simulation for each magnetic configuration from scratch. Instead, embodiments of the invention may achieve the same accuracy as prior solutions while reducing processing power and time necessary by transforming precalculated magnetic field distributions for each magnetic subcomponent in a given magnetic configuration based on each corresponding magnetic subcomponent's location and orientation, calculating a total magnetic field distribution for the configuration by adding each of the transformed precalculated magnetic field distributions for the configuration to get, and evaluating the calculated total magnetic field distribution. By utilizing a small number of pre-calculated magnetic simulations done using a complex numerical software, a significantly faster and cost-effective system and method for magnetic optimization over a wide range of parameters may be achieve.

Embodiments of the invention may also reduce the processing power and time necessary for simulating magnetic field/gradients/forces distribution and magnetic configuration by allowing the total magnetic field distributions of different magnetic configurations to be calculated in parallel, and allowing the different magnetic configurations to be evaluated and optimized in parallel.

### BRIEF DESCRIPTION OF THE DRAWINGS

Dimensions of features shown in the figures are chosen for convenience and clarity of presentation and are not necessarily shown to scale. The invention, both as to organization and method of operation, together with objects, features and advantages thereof, can be understood by reference to the following detailed description when read with the accompanied non-limiting drawings. Embodiments of the invention are illustrated by way of example and not limitation in the figures of the accompanying drawings, in which like reference numerals indicate corresponding, analogous or similar elements.

FIG. 1 is a block diagram of a computing device used with or executing embodiments of the present invention.

FIG. 2 is an exemplary flowchart of a method for magnetic configuration optimization, according to embodiments of the present invention

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element. is an exemplary system for magnetic configuration optimization, according to embodiments of the present invention.

### DETAILED DESCRIPTION OF THE INVENTION

Dimensions of features shown in the figures are chosen for convenience and clarity of presentation and are not necessarily shown to scale. The invention, both as to organization and method of operation, together with objects, features and advantages thereof, can be understood by reference to the following detailed description when read with the accompanied non-limiting drawings. Embodiments of the invention are illustrated by way of example and not limitation in the figures of the accompanying drawings, in which like reference numerals indicate corresponding, analogous or similar elements.

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the invention pertain to simulating magnetic field distributions of a plurality of different configurations of magnetic subcomponents (permanent magnets and/or electromagnets), in order to determine at least performance metric/score for each configuration based on a particular purpose or magnetic field parameter to be optimized (e.g., a performance score could be based on a maximal strength of the magnetic field in a particular direction, or a measure of the standard deviation of the field in a target area).

The performance score/metric may be based on what a user is trying to optimize, such as a magnetic field parameter, such as a measure of magnetic field strength in a particular direction, or a measure of a standard magnetic field deviation of the configuration being evaluated. The performance score/metric may be calculated utilizing any well-defined function of the magnetic field distribution generated by the magnetic subcomponents of a given configuration.

Embodiments of the invention may utilize a field distribution dictionary, which maps of every possible different magnetic subcomponent of each of a plurality of magnetic configurations to a pre-calculated magnetic field distribution of magnetic subcomponent, and may utilize, for each magnetic configuration to be evaluated, a configuration file, which describes the corresponding magnetic configuration based on its magnetic sub-components. The pre-calculated magnetic field distributions for each magnetic sub-component of a configuration to be evaluated/optimized may be retrieved from the field distribution dictionary, and, each retrieved pre-calculated magnetic field distribution may be transformed, if necessary, based on the location and orientation of the respective magnetic sub-component described in the configuration file. Using the superposition principle, the total magnetic field of the configuration may be calculated by adding the transformed magnetic field distributions for configuration, and performance metrics may be calculated from the total magnetic field of the configuration.

Data structure mag_desc

Embodiments of the invention may utilize a sub-component array (mag_desc) for each different magnetic subcomponent of each of the plurality of magnetic configurations to be evaluated/optimized, which describes the sub-component. For example, for a permanent magnet, the array (mag_desc) may describe the material (e.g., ND52), the geometry/shape (e.g., cylinder or cube), and the dimensions of the permanent magnet. For an electromagnet, the array (mag_desc) may describe the diameter of the coil, the material used for the wire, the number of turns of the wire, the current applied to the electromagnet, and the dimensions of the electromagnet.

Data structure field_dictionary

A field distribution dictionary (field_dictionary) may map, each different magnetic subcomponent of each of the plurality of magnetic configurations to be evaluated/optimized to a corresponding pre-calculated magnetic field distribution. In some embodiments of the invention, for each magnetized direction of each different magnetic subcomponent of each of the plurality of magnetic configurations to be evaluated/optimized, the subcomponent and magnetized direction may be mapped to its corresponding pre-calculated magnetic field distribution.

The magnetic field distribution for a subcomponent may be precalculated based on the information in the corresponding subcomponent array (mag_desc) and the magnetized direction of the sub-component.

An example, of a table in a field distribution dictionary (field_dictionary) may be:

| | Magnetization unit | | Pre-calculated |
|---|---|---|---|
| | vector (in shape | Sub-component | magnetic field |
| Shape type | coordinates) | description | distribution |
| Permanent Magnet A | 0, 0, 1 | mag_desc1 | precalc_field1 |
| Permanent Magnet B | 0, 1, 0 | mag_desc2 | precalc_field2 |
| Permanent Magnet A | $\frac{( 1 , 1 , 1 )}{\sqrt{3}}$ | mag_desc3 | precalc_field3 |
| Electromagnet A | 0, 1, 0 | mag_desc4 | precalc_field4 |

Data_structure precalc_field

A pre-calculated field array (precalc_field) may describe the magnetic field distribution of a magnetic subcomponent for a particular magnetized direction. The pre-calculated field array (precalc_field) may be a 3D array of magnetic field strength vectors (field_strength), which each describes the magnetic field strength at a specific point in space. A magnetic field strength vector (field_strength) may be a vector with 6 elements (x, y, z, Bₓ, B_{y}, B_{z}). The first three elements (x, y, z) may be the coordinates of a given point in three dimensions, in specific units (e.g., mm). The last 3 elements (Bₓ, B_{y}, B_{z}) may be the magnetic field components at a given point.

The pre-calculated field array (precalc_field) structure may correspond to a given volume (e.g., 500 mm*500 mm*500 mm), with a given level of spatial resolution (e.g., 1 mm). The assumption is that the this is the magnetic field generated by a particular magnetic sub-component.

Data structure magnetic_config

The configuration file (magnetic-config) describing a given configuration of permanent magnets and/or electromagnets may be a data structure containing a list of information on each of the magnetic subcomponents of the configuration, such as shape type of a permanent magnet or an electromagnet), the magnetized direction of the sub-component, and the sub-component's location and orientation in space.

An example, of a configuration file for a configuration of magnets may be:

| | Magnetization unit | | |
|---|---|---|---|
| | vector | Location of center | Angular orientation |
| Shape type | (in shape coordinates) | (in global coordinates) | (in global coordinates) |
| Permanent Magnet A | 0, 0, 1 | 0, 0, 0 (cm) | 0, 0, 0 (rad) |
| Permanent Magnet B | 0, 1, 0 | 0, 0, 2 (cm) | 0, 0, 0 (rad) |
| Permanent Magnet A | $\frac{( 1 , 1 , 1 )}{\sqrt{3}}$ | 0, 3, 0 (cm) | $0 , \frac{π}{2} , \frac{3 π}{2} rad$ |
| Electromagnet A | 0, 1, 0 | 0, 9, 2 (cm) | 0, 0, 0 (rad) |

The location of a center of any subcomponent must be at x, y, z>=0.

Data structure target_area

Embodiments of the invention may utilize a data structure (target_area) defining a target volume/area for calculating the magnetic field of a configuration of magnets. The structure may contain 6 numbers (an X range, a Y range, a Z range) to describe the target volume/area. The units should be consistent with the units used in other structures, such as the pre-calculated field array (precalc_field).

Function get_field (magnetic_config, field_dictionary, target_area)

Embodiments of the invention may perform a function (get_field) to, for each magnetic subcomponent of a given magnetic configuration being evaluated/optimized, retrieve the corresponding pre-calculated 3D field array (precalc_field) for the magnetic field distribution of the magnetic subcomponent from the field distribution dictionary (field_dictionary), transform each pre-calculated 3D field array (precalc_field) to the position and orientation of the subcomponent, and adding (matrix addition) each of transformed pre-calculated 3D field array (precalc_field) of the configuration. Based on the superposition principle, the resulting sum of transformed matrices should be equal to total magnetic field distribution of the overall magnetic configuration. Then the overall magnetic configuration may be utilized to evaluate the configuration over a wide range of parameters while avoiding running a complex simulation for it from scratch.

The total magnetic field distribution for a magnetic configuration may be stored in a 3D field array (total_field) of field_strength vectors. Each vector in the array may describes the magnetic field strength of the overall magnetic configuration at a specific point in space. The entire structure corresponds to a given volume (e.g., 500 mm*500 mm*500 mm), with a given level of spatial resolution (e.g., 1 mm). The assumption is that the this is the magnetic field generated by a particular permanent magnet configuration.

Function calc_force_torque (total_field, magnetic_config, target_area)

Embodiments of the invention may perform a function (calc_force_torque) to retrieve a particular magnetic configuration (magnetic_config) and its corresponding magnetic field distribution (total_field), calculate the gradient of the total magnetic field (total_field) of the configuration in any point in the target volume/area (target_area). Embodiments of the invention may calculate the force and torque on a particular object, under specific assumptions, at any point in the target volume/area (target_area). For example, this could be the force and torque on a magnetic catheter of a particular size, located in the target area. The force and torque may then be stored in a data structure (precalc_force_torque). The entire precalc_force_torque structure may correspond to a given volume (e.g., 500 mm*500 mm*500 mm), with a given level of spatial resolution (e.g., 1 mm).

The force and torque data structure (precalc_force_torque) for a configuration of magnets may be an array of vectors (force_torque), each describing the magnetic field generated force and torque at a specific point in space, on a particular object. The force_torque vector may have 9 elements (x,y,z, Fₓ, F_{y}, F_{z}, Bₓ, B_{y}, B_{z}). The first 3 elements (x,y,z) may be the coordinates of a given point in 3D, in specific units (e.g., mm). The next 3 elements (Fₓ, F_{y}, F_{z}) may be the X,Y,Z magnetic field force components on a particular object at that point, and the last 3 elements (Bₓ, B_{y}, B_{z}) may be the 3 torque components on the same object at that point.

Function calc_performance (precalc_field, precalc_force_torque , magnetic_config, target_area)

This function may receive a particular magnetic configuration a particular magnetic configuration (magnetic_config) and its corresponding magnetic field distribution (total_field), and calculates an at least one performance score/meteric for the configuration based on what the user wishes to maximize (such as a magnetic field parameter). When there are multiple parameters to maximize, this function may calculate an aggregate performance score (an integer array) based on each of the parameters to maximize. For example, the performance score/metric may be the maximal strength of the magnetic field in a particular direction (if the user wishes to maximize it), or a measure of the standard deviation of the field in the target area (if the user wants to maximize field uniformity). In some embodiments, at least one performance score/metric for a configuration may be based on the pre-calculated force and torque data structure (precalc_force_torque) for the configuration.

Binary Function check_magnetic_config(magnetic_config, field_dictionary, target_area)

Embodiments of the invention may utilize a function (check_magnetic_config) that tests a particular magnetic configuration and makes sure it is valid for the field calculation process using the superposition principle. Specifically, it checks for the following violations:
subcomponents that are not included in the field_dictionary;
spatial overlap between subcomponents (this means this shape is impossible in real world); and
subcomponents which are too far from (e.g., more than a predefined distance from) the target_area, to know how much they contribute to the total field.

If any of these violations occurs, the function returns 0 and terminates the calculations for the configuration. Otherwise it returns 1 and proceeds.

Function display_magnetic_config(magnetic_config)

Embodiments of the invention may utilize a function (display_mangetic config), which may show an image of the magnetic configuration in 3D, including arrows showing the magnetization of each subcomponent. This may be useful for visualizing/debugging

### Example of Overall Parallelized Optimization Process

Embodiments of the invention may start by generating a field distribution dictionary (field_dictionary) mapping each of a plurality of magnetic subcomponents to a precalculated magnetic field distribution. The information describing each of the plurality of magnetic subcomponents may be imported and organized into a sub-component array (mag_desc) for each subcomponent, and/or the plurality of magnetic subcomponents and corresponding description may be randomly generated using a variety of basic shapes (e.g., using a magnetic simulation software like Maxwell/Opera/ANSYS)

After the field distribution dictionary (field_dictionary) has been generated, a plurality of magnetic configurations (magnetic-config) may be generated by combining more than one of the magnetic subcomponents in the field distribution dictionary, and each.

The data may be parallelized across multiple processors/computers (indexed i). Each instance may get the following data:
A single magnetic configuration structure structure (denoted as magnetic_config_arrayᵢ)
the target_area structure
and the field_dictionary structure

Each instance may perform the following pseudocode:

/* Check if all inputs are valid (could be important if this is a randomly
generated magnetic configuration*/
Valid_config=check_magnetic_config(magnetic_config{i},
field_dictionary, target_area)
If(~valid_config)
Exit
/* If they are valid, calculate the field using superposition*/
precalc_field =get_field (magnetic_config, field_dictionary,
target_area)
/* Now calculate the forces and torques*/
precalc_force_torque =calc_force (precalc_field, magnetic_config,
target_area)
/* Now calculate the performance scores*/
int array performance_array =calc_performance(precalc_field,
precalc_force_torque , magnetic_config, target_area)
*/return the performance score vector for the given configuration
performance matrix{i}= performance_array

This pseudocode may be run in parallel on multiple instances (e.g., utilizing Amazon Web Services' cloud computing services), resulting in a significant speedup, and is amendable for different iterative optimization schemes (e.g., genetic algorithms, other AI algorithms).

Embodiments of the invention may then take the aggregate array of performance scores and select the configuration that has the best performance score.

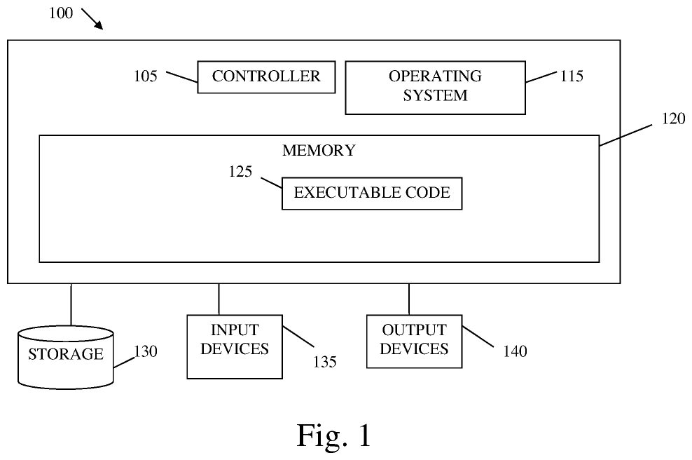

Reference is made to FIG. 1, which is a block diagram of a computing device used with or executing embodiments of the present invention. Computing device 100 may include a controller 105 that may be, for example, a central processing unit processor (CPU), a chip or any suitable computing or computational device, an operating system 115, a memory 120, a storage 130, an input devices 135 and an output devices 140.

Operating system 115 may be or may include any code segment designed and/or configured to perform tasks involving coordination, scheduling, arbitration, supervising, controlling or otherwise managing operation of computing device 100, for example, scheduling execution of programs. Operating system 115 may be a commercial operating system. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units.

Executable code 125 may be any executable code, e.g., an application, a program, a process, task or script. Executable code 125 may be executed by controller 105 possibly under control of operating system 115. For example, executable code 125 may be an application that performs methods for magnetic configuration optimization as described herein. Where applicable, executable code 125 may carry out operations described herein in real-time. Computing device 100 and executable code 125 may be configured to update, process and/or act upon information at the same rate the information, or a relevant event, are received. In some embodiments, more than one computing device 100 may be used. For example, a plurality of computing devices that include components similar to those included in computing device 100 may be connected to a network and used as a system. For example, methods for magnetic configuration optimization as described herein may be performed in real-time by executable code 125 when executed on one or more computing devices such computing device 100.

Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage 130 and may be loaded from storage 130 into memory 120 where it may be processed by controller 105.

In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a modem, printer or facsimile machine, a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

Some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

Unless explicitly stated, the method embodiments described herein are not constrained to a particular order or sequence. Additionally, some of the described method embodiments or elements thereof can occur or be performed at the same point in time.

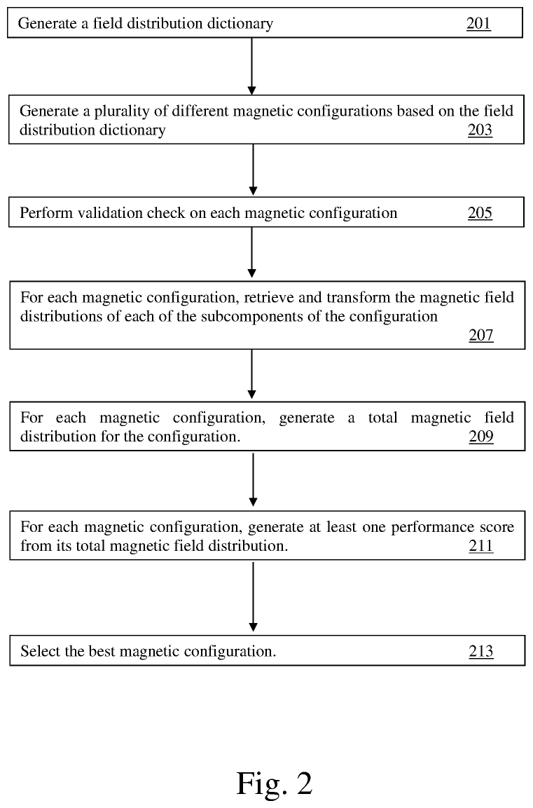

Reference is made to FIG. 2, which is an exemplary flowchart of a method for magnetic configuration optimization, according to embodiments of the present invention.

The operations of FIG. 2 may be performed using a processor (e.g., the computing device 100 of FIG. 1), a system of processors (e.g., a plurality of computing devices 100 of FIG. 1), or using other suitable systems.

In step 201, the one or more processors may generate a field distribution dictionary mapping each of a plurality of magnetic subcomponents to a corresponding pre-calculated magnetic field distribution for a predefined area. The magnetic field distribution for each magnetic subcomponent in the field distribution dictionary may be precalculated by the one or more processors based on the parameters of the corresponding magnetic subcomponent, and a direction of magnetization or a direction of current in the corresponding magnetic subcomponent. The subcomponent parameters for a permanent magnet may include a material of the magnetic subcomponent, a shape of the magnetic subcomponent, and dimensions of the magnetic subcomponent. The subcomponent parameters for a electromagnet may include a diameter of a coil of the magnetic subcomponent, a type of material and a diameter of a wire of the magnetic subcomponent, a number of turns of the magnetic subcomponent, a current applied to the magnetic subcomponent.

In step 203, the one or more processors may generate a plurality of different magnetic configurations based on the magnetic subcomponents in the field distribution dictionary. For example, the one more processors may randomly select subcomponents for a magnetic configuration from the field distribution dictionary, and randomly assign a location and an orientation for each magnetic subcomponent of the configuration.

A first configuration of magnets may be different a second configuration of magnets if either: one configuration has at least one magnetic subcomponent which is not a magnetic subcomponent in the other configuration, or, if the two configurations have the same magnetic subcomponents, at least one of the magnetic subcomponent's location in the first configuration is different from its location in the second configuration.

In some embodiments of the invention, each magnetic configuration only includes magnetic subcomponents that are mapped in the field distribution dictionary. In other embodiments, one or more of the plurality of magnetic configurations may be received, and, any subcomponent that is not already mapped in the field distribution dictionary may be added to the field distribution and mapped to a corresponding magnetic field distribution.

In step 205, the one or more processors may perform a validation check on each of the plurality of different magnetic configurations of step 203. The validation check may comprise checking if:
any subcomponents of a given magnetic configuration are not included in the field_dictionary;
the location of each magnetic subcomponent of the given magnetic configuration is within the predefined distance from the predefined area; and/or
there is spatial overlap between locations of subcomponents in the given magnetic configuration; and

If subcomponents of a given magnetic configuration are not included in the field distribution dictionary (field_dictionary), then either the one or more processors may not proceed to calculate a total magnetic field distribution for the given magnetic configuration, or the one or more processor may add any subcomponents that are not included in the field distribution dictionary (field_dictionary) and map those subcomponents to corresponding magnetic field distributions.

If the location of each magnetic subcomponent of the given configuration is within the predefined distance from the predefined area, and none of the locations of the magnetic subcomponents of the given configuration overlap, the one or more processors may proceed to calculate the total magnetic field distribution of the given configuration. If either at least one magnetic subcomponent of the given configuration is outside of a predefined distance from the predefined area, or the location of at least two magnetic subcomponents of the configuration overlap, the one or more processors may not calculate the total magnetic field distribution of the given configuration.

In step 207, for each magnetic configuration, the one or more processors may retrieve the corresponding magnetic field distribution of each magnetic subcomponent from the field distribution dictionary (field_dictionary) and transform each retrieved magnetic field distribution to the location and orientation of the corresponding magnetic subcomponent.

In step 209, for each magnetic configuration, the one or more processors may generate a total magnetic field distribution for the configuration by adding the transformed magnetic field distributions of each of its magnetic subcomponents. For each magnetic configuration, the one or more processors may calculate, as a function of a gradient of the first total magnetic field distribution on a particular object at at least one point in a predefined area, a magnetic force and a torque at the at least one point in the predefined area.

In step 211, for each magnetic configuration, the one or more processor may generate at least one performance score from its total magnetic field distribution based on a magnetic field parameter to be optimized. In some embodiments of the invention, the one or more processors may generate an aggregate performance score from its total magnetic field distribution based on more than one magnetic field parameter to be optimized.

In step 213, the one or more processors selects the best magnetic configuration from the plurality of magnetic configurations based on the at least one performance score or the aggregate performance score.

It will thus be seen that the objects set forth elsewhere herein, among those made apparent from the preceding description, are efficiently attained and, because certain changes may be made in carrying out the method described elsewhere herein and in the construction(s) set forth without departing from the spirit and scope of the invention, it is intended that all matter contained in the above description and shown in the accompanying drawings shall be interpreted as illustrative and not in a limiting sense.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

It is also to be understood that the following claims are intended to cover all of the generic and specific features of the invention herein described and all statements of the scope of the invention which, as a matter of language, might be said to fall therebetween.

1. A system for magnetic configuration optimization comprising:
one or more memories storing, a field distribution dictionary mapping each of a plurality of magnetic subcomponents to a corresponding magnetic field distribution for a predefined area; wherein the plurality of mapped magnetic subcomponents include each magnetic subcomponent of a first configuration of magnets; and
one or more processors configured to,
receive a location and orientation of each magnetic subcomponent in a first configuration of magnets,
for each magnetic subcomponent of the first configuration, transform the corresponding magnetic field distribution to the location and orientation of the magnetic subcomponent,
add each of the transformed magnetic field distributions of the magnetic subcomponents of the first configuration to generate a first total magnetic field distribution of the first configuration for the predefined area, and
generate at least one performance score for the first configuration of magnets from the first total magnetic field distribution based on a first magnetic field parameter to be optimized.

2. The system of claim 1, wherein each of the plurality of mapped magnetic field distributions were precalculated by the one or more processors based on:
parameters of the corresponding magnetic subcomponent; and
a direction of magnetization or a direction of current in the corresponding magnetic subcomponent.

3. The system of claim 2, wherein:
for a magnetic subcomponent that is a permanent magnet, the parameters of the magnetic subcomponent include a material of the magnetic subcomponent, a shape of the magnetic subcomponent, and dimensions of the magnetic subcomponent; and
for a magnetic subcomponent that is an electromagnet, the parameters of the magnetic subcomponent include a diameter of a coil of the magnetic subcomponent, a type of material and a diameter of a wire of the magnetic subcomponent, a number of turns of the magnetic subcomponent, a current applied to the magnetic subcomponent.

4. The system of claim 1, wherein the one or more processors are configured to generate a second configuration of magnets by:
randomly selecting magnetic subcomponents of the second configuration from the plurality of mapped magnetic subcomponents, and
randomly assign a location and an orientation for each magnetic subcomponent of the first configuration,
wherein the second configuration of magnets either has at least one magnetic subcomponent which is not a magnetic subcomponent in the first configuration, or, if the first configuration and second configuration have the same magnetic subcomponents, at least one of the magnetic subcomponent's location in the first configuration is different from its location in the second configuration.

5. The system of claim 4, wherein the one or more processors are further configured to, if the location of each magnetic subcomponent of the second configuration is within the predefined distance from the predefined area and/or if none of the locations of the magnetic subcomponents of the second configuration overlap:
for each magnetic subcomponent of the second configuration of magnets, transform the corresponding magnetic field distribution to the location and orientation of the magnetic subcomponent,
add each of the transformed magnetic field distributions of the magnetic subcomponents of the second configuration to generate a second total magnetic field distribution of the second configuration for the predefined area; and
generate at least one performance score for the second configuration from a second total magnetic field distribution based on the first magnetic field parameter to be optimized.

6. The system of claim 1, wherein the one or more processors are further configured to:
generate at least one performance score for a second configuration of magnets from a second total magnetic field distribution based on the first magnetic field parameter to be optimized, wherein the second configuration of magnets either has at least one magnetic subcomponent which is not a magnetic subcomponent in the first configuration, or, if the first configuration and second configuration have the same magnetic subcomponents, at least one of the magnetic subcomponent's location in the first configuration is different from its location in the second configuration; and
suggest an optimized configuration of magnets based on the at least one performance score for the first configuration and the at least one performance score for the second configuration.

7. The system of claim 6, wherein:
a first processor of the one or more processors is configured to:
transform the corresponding magnetic field distributions of the magnetic subcomponents of the first configuration,
generate the first total magnetic field distribution, and
generate the at least one performance score for the first configuration; and
a second processor of the one or more processors is configured to:
transform the corresponding magnetic field distributions of the magnetic subcomponents of the second configuration,
generate the second total magnetic field distribution, and
generate at least one performance score for the second configuration.

8. The system of claim 1, wherein generating the first performance score comprises the one or more processors calculating, as a function of a gradient of the first total magnetic field distribution on a particular object at at least one point in the predefined area, a magnetic force and a torque at the at least one point in the predefined area.

9. The system of claim 1, wherein:
the one or more processors receives the first magnetic field parameter and at least one other magnetic field parameter to be optimized; and
the one or more processors are further configured to generate a performance score from the first total magnetic field distribution for each of the at least one other magnetic field parameter to be optimized.

10. The system of claim 1, wherein the first magnetic field parameter to be optimized is magnetic field strength in a particular direction, or a measure of a standard magnetic field deviation in the predefined area.

11. A method for magnetic configuration optimization comprising:
receiving a location and orientation of each magnetic subcomponent in a first configuration of magnets;
for each magnetic subcomponent of a first configuration of magnets, retrieving, from a field distribution dictionary, a pre-calculated magnetic field distribution corresponding to the magnetic subcomponent; wherein the field distribution dictionary maps each of a plurality of magnetic subcomponents to a corresponding magnetic field distribution for a predefined area;
for each magnetic subcomponent of the first configuration, transforming the corresponding magnetic field distribution to the location and orientation of the magnetic subcomponent
adding each of the transformed magnetic field distributions of the magnetic subcomponents of the first configuration to generate a first total magnetic field distribution of the first configuration for the predefined area, and
generating at least one performance score for the first configuration of magnets from the first total magnetic field distribution based on a first magnetic field parameter to be optimized.

12. The method of claim 11, wherein each of the plurality of mapped magnetic field distributions were precalculated based on:
parameters of the corresponding magnetic subcomponent; and
a direction of magnetization or a direction of current in the corresponding magnetic subcomponent.

13. The method of claim 12, wherein:
for a magnetic subcomponent that is a permanent magnet, the parameters of the magnetic subcomponent include a material of the magnetic subcomponent, a shape of the magnetic subcomponent, and dimensions of the magnetic subcomponent; and
for a magnetic subcomponent that is an electromagnet, the parameters of the magnetic subcomponent include a diameter of a coil of the magnetic subcomponent, a type of material and a diameter of a wire of the magnetic subcomponent, a number of turns of the magnetic subcomponent, a current applied to the magnetic subcomponent.

14. The method of claim 11, wherein the method further comprises:
randomly selecting magnetic subcomponents of the second configuration from the plurality of mapped magnetic subcomponents, and
randomly assigning a location and an orientation for each magnetic subcomponent of the first configuration,
wherein the second configuration of magnets either has at least one magnetic subcomponent which is not a magnetic subcomponent in the first configuration, or, if the first configuration and second configuration have the same magnetic subcomponents, at least one of the magnetic subcomponent's location in the first configuration is different from its location in the second configuration.

15. The method of claim 14, wherein the method further comprise, if the location of each magnetic subcomponent of the second configuration is within the predefined distance from the predefined area and/or if none of the locations of the magnetic subcomponents of the second configuration overlap:
for each magnetic subcomponent of the second configuration of magnets, transforming the corresponding magnetic field distribution to the location and orientation of the magnetic subcomponent,
adding each of the transformed magnetic field distributions of the magnetic subcomponents of the second configuration to generate a second total magnetic field distribution of the second configuration for the predefined area; and
generating at least one performance score for the second configuration from a second total magnetic field distribution based on the first magnetic field parameter to be optimized.

16. The method of claim 11, wherein the method further comprises:
generating at least one performance score for a second configuration of magnets from a second total magnetic field distribution based on the first magnetic field parameter to be optimized, wherein the second configuration of magnets either has at least one magnetic subcomponent which is not a magnetic subcomponent in the first configuration, or, if the first configuration and second configuration have the same magnetic subcomponents, at least one of the magnetic subcomponent's location in the first configuration is different from its location in the second configuration; and
suggesting an optimized configuration of magnets based on the at least one performance score for the first configuration and the at least one performance score for the second configuration.

17. The method of claim 11, wherein generating the first performance score comprises calculating, as a function of a gradient of the first total magnetic field distribution on a particular object at at least one point in the predefined area, a magnetic force and a torque at the at least one point in the predefined area.

18. The method of claim 11, wherein:
the one or more processors receives the first magnetic field parameter and at least one other magnetic field parameter to be optimized; and
the one or more processors are further configured to generate a performance score from the first total magnetic field distribution for each of the at least one other magnetic field parameter to be optimized.

19. The method of claim 11, wherein the first magnetic field parameter to be optimized is magnetic field strength in a particular direction, or a measure of a standard magnetic field deviation in the predefined area.

20. A method for magnetic configuration optimization comprising:
generating a plurality of different configurations of magnets from magnetic subcomponents that are mapped to magnetic field distributions in a field distribution dictionary;
for each of the plurality of different configurations:
for each magnetic subcomponent of the configuration, retrieving, from the field distribution dictionary, the pre-calculated magnetic field distribution corresponding to the magnetic subcomponent,
for each magnetic subcomponent of the configuration, transforming the corresponding magnetic field distribution to a location and an orientation of the magnetic subcomponent in the configuration,
adding each of the transformed magnetic field distributions of the magnetic subcomponents of the configuration to generate a total magnetic field distribution of the configuration for the predefined area, and
generating a performance score for the configuration from the total magnetic field distribution based on at least one first magnetic field parameter to be optimized; and
selecting the configuration with the highest performance score.
